SEQUENCE LISTING (3 sequences)

SEQ ID NO: 1 - protein, 4 aa, Artificial Sequence
  poly(amino acid) block
RGDS

SEQ ID NO: 2 - protein, 5 aa, Artificial Sequence
  poly(amino acid) block
VPGVG

SEQ ID NO: 3 - protein, 5 aa, Artificial Sequence
  poly(amino acid) block
  misc_feature (4)..(4): X/Xaa can be one amino acid residue selected       from the group consisting of Leu, ILE, Met, Val, Glu(COOCH3),       Glu(COOH), Cys, His, LysNH3, Lys and Asp(COOH).
VPGXG

(19) United States
(12) Patent Application Publication
(10) Pub. No.: US 2019/0110497 A1
(43) Pub. Date: Apr. 18, 2019

(54) GUM BASES AND CHEWING GUMS USING THERMOSENSITIVE POLYMERS

(71) Applicant: WM. WRIGLEY JR. COMPANY, Chicago, IL (US)

(72) Inventor: Jingping LIU, Chicago, IL (US)

(21) Appl. No.: 15/764,504

(22) PCT Filed: Sep. 30, 2016
(86) PCT No.: PCT/US16/54909

§ 371 Date: Mar. 29, 2018

Related U.S. Application Data
(60) Provisional application No. 62/235,327, filed on Sep. 30, 2015.

(51) Int. Cl. A23G 4/08

(52) U.S. Cl. CPC A23G 4/08; A23V 2002/00

(57) ABSTRACT

The present application discloses compositions of chewing gum base that can include at least one thermosensitive polymer. The thermosensitive polymer can include poly(N-isopropylacrylamides) or triblock copolymer polyoxyethylene-polyoxypropylene-polyoxyethylene. The present application provides for methods of making gum bases and chewing gum formulations.

### CROSS-REFERENCE TO RELATED APPLICATION

This application claims priority to U.S. Provisional Application Serial No. 62/235,327, filed on Sep. 30, 2015, which is incorporated in its entirety herein.

### SEQUENCE LISTING

The instant application contains a Sequence Listing which has been submitted electronically in ASCII format and is hereby incorporated by reference in its entirety. Said ASCII copy, created on Sep. 30, 2016, is named “069269_0195_SEQ_Lising_ST25.txt” and is 966 bytes in size.

### FIELD

The presently disclosed subject matter relates to chewing gum base compositions comprising one or more thermosensitive polymers. Such compositions have improved removability from surfaces.

### BACKGROUND

The insoluble portion of chewing gums can act as an adhesive upon various substrates (e.g., sidewalks) at ambient temperature. As a result, gum-littering and adhesion is an ongoing issue for the gum industry.

At average mouth temperature, the chewing gum base is water-insoluble, which prevents it from falling apart during chewing. The solubility of conventional gum base does not change with a change in temperature. However, if chewing gums comprise polymers with Low Critical Solution Temperatures (LCST) (i.e., in the vicinity of or below mouth temperature), and the ambient temperature is lower than the mouth temperature, the cohesion of the LCST gum cud/base will vary dramatically after littering. For example, when gum cud is inside the mouth, the saliva has little solvation effect on the LCST polymers. However, when gum cud is discarded on the sidewalk, and the ambient temperature is lower than the LCST, the gum cud has higher tendency to dissolve or disintegrate upon exposure to water, which could be from saliva, rain or a cleaning solution. This exposure results in a change of the viscoelasticity and the water resistance of the gum cud. Such changes to gum viscoelasticity then alter the ability of the gum cud to adhere to various surfaces when exposed to moisture and different temperatures upon disposal.

Therefore, there is a need in the art to formulate chewing gum with ideal viscoelastic properties and water-insolubility at body temperature (during chewing) and at ambient temperature (after disposal) to increase the removability of chewing gum and/or gum cud from various surfaces.

### SUMMARY OF THE INVENTION

The presently disclosed subject matter is directed to a chewing gum base comprising at least one thermosensitive polymer.

In certain embodiments, the thermosensitive polymer has a Lower Critical Solution Temperature (LCST) of from about 0° C. to about 40° C. In certain embodiments, the thermosensitive polymer has a LCST of from about 20° C. to about 37° C. In other embodiments, the thermosensitive polymer has a LCST of from about 25° C. to about 35° C.

In certain embodiments, the at least one thermosensitive polymer is selected from the group consisting of poly(N-isopropylacrylamides), cross-linked poly(N-isopropylacrylamides), polyoxypropylene-polyoxyethylene block copolymers, triblock copolymer polyoxyethylene-polyoxypropylene-polyoxyethylene, N-substituted acrylamide derivatives, poly(amino acid)s, cellulose ethers, starch ethers, poly(ether-ester)block copolymers, chitosan-beta-glycerophosphate, and combinations thereof. In certain embodiments, the at least one thermosensitive polymer is an N-substituted acrylamide derivative, wherein the N-substituted acrylamide derivative is selected from the group consisting of N-n-propylacrylamide, N,N-diethylacrylamide, N-cyclopropyl methacrylamide, and combinations thereof.

In certain embodiments, the at least one thermosensitive polymer is a poly(amino acid), wherein the poly(amino acid) is selected from the group consisting of methacryloyl glycine methyl ester, methacryloyl proline, methacryloyl phenylalanine methyl ester, methacryloyl alanine methyl ester; polymers containing an Arg-Gly-Asp-Ser sequence or arginine-glycine-aspartic acid-serine blocks (RGDS, SEQ ID NO:1); poly(amino acid)s containing two different pentamer blocks: where one block has a Val-Pro-Gly-Val-Gly (VPGVG, SEQ ID NO:2) sequence, and the second block has a Val-Pro-Gly-X-Gly (VPGXG, SEQ ID NO:3) sequence, in which X can be one amino acid residue selected from the group consisting of Leu, ILE, Met, Val, Glu(COOCH₃), Glu(COOH), Cys, His, LysNH₃, Lys and Asp(COOH); and combinations thereof.

In certain embodiments, the at least one thermosensitive polymer is a cellulose ether. In certain embodiments, the cellulose ether is hydroxy-propyl cellulose. In certain embodiments, the at least one thermosensitive polymer is a starch ether. In certain embodiments, the starch ether is 3-[2-butoxy(ethoxy)m]-2-hydroxypropyl starch ether (BEmS) (where m=0, 1, or 2).

In certain embodiments, the at least one thermosensitive polymer is triblock copolymer polyoxyethylene-polyoxypropylene-polyoxyethylene, and the base further comprises from about 1% to about 40% by weight ethylene oxide.

In certain embodiments, the one or more thermosensitive polymers is present in an amount of from about 1% to about 35% by weight. In certain embodiments, the one or more thermosensitive polymers is present in an amount of from about 10% to about 25% by weight. In certain embodiments, the one or more thermosensitive polymers is present in an amount of from about 1% to about 10% by weight.

The presently disclosed subject matter is directed to a chewing gum formulation comprising the chewing gum bases described herein.

The foregoing has outlined broadly the features and technical advantages of the present application in order that the detailed description that follows can be better understood. Additional features and advantages of the application will be described hereinafter which form the subject of the claims of the application. It should be appreciated by those skilled in the art that the conception and specific embodiment disclosed can be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### DETAILED DESCRIPTION

As noted above, to date, there remains a need in the art for chewing gum and chewing gum base that can be easily removed from solid surfaces. The presently disclosed subject matter addresses this need through the use of thermosensitive polymers in gum base and chewing gum compositions.

### 1. Definitions

The terms used in this specification generally have their ordinary meanings in the art, within the context of this disclosed subject matter and in the specific context where each term is used. Certain terms are discussed below, or elsewhere in the specification, to provide additional guidance to the practitioner in describing the compositions and methods of the disclosed subject matter and how to make and use them.

Although some terms are referred to in the singular, it is understood that such references can also encompass the plural. Finally, all references cited herein are incorporated by reference.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

Unless otherwise specified, all percentages used herein are weight percent. All percentages and ratios used herein are by weight of the total composition and all measurements made are at 25° C., unless otherwise designated.

As used herein, “thermosensitive polymer” means a polymer that exhibits a drastic change of its physical properties with temperature. As used herein, the term “thermosensitive polymer” is used interchangeably with “temperature-sensitive polymer,” “thermoresponsive polymer,” or “temperature-responsive polymer.”

As used herein, the terms “Lower Critical Solution Temperature” or LCST refer to the transition temperature, below which a thermosensitive polymer is soluble in the solvent and above which the thermosensitive polymer becomes insoluble.

As used herein, the terms “Volume Phase Transition Temperature” or VPTT refer to the transition temperature, below which a thermosensitive polymer hydrogel swells and above which the hydrogel collapses. Volume Phase Transition Temperature can simply be referred to as transition temperature herein.

As used herein, the term “gum cud” refers to the remaining portion of a chewing gum formulation after mastication.

As used herein, the term “chewing gum” refers to a flavored substance intended for chewing. The term as used herein also includes bubble gum and confectionery products containing chewing gum. In certain embodiments, chewing gum forms include, but are not limited to, tablets, sticks, solid balls, hollow balls, cut and wrap, and pellets or pillows. As used herein, chewing gum contains a water insoluble base portion and a water-soluble bulk portion.

As used herein, the term “cold flow” refers to the viscous flow of a gum base composition or chewing gum formulation at ordinary, e.g., ambient temperatures.

### 2. Gum Base Compositions

The presently disclosed subject matter relates to compositions of chewing gum, and more specifically to chewing gum bases, which can include thermosensitive polymers. The addition of at least one thermosensitive polymer can improve the viscoelasticity and removability of chewing gum and/or chewing gum cud from various surfaces.

In general, a chewing gum composition comprises (i) a water-soluble bulk portion, (ii) water insoluble flavoring agents, and (iii) a water insoluble chewable gum base portion. The water-soluble bulk portion dissipates with a portion of the water insoluble flavoring agents over a period of time during chewing. However, the water insoluble gum base portion is retained in the mouth throughout the chew, forming what is known as gum cud. The produced gum cud is an adhesive substance that is difficult to remove once attached to dry surfaces (e.g., sidewalks and the like).

### 2.1 Insoluble Gum Bases

Water insoluble gum bases can contain any combination of elastomers, vinyl polymers, elastomer plasticizers, fillers, softeners, waxes and other optional ingredients such as colorants and antioxidants. Gum bases are complex, amorphous polymer blends. In one aspect, the unique viscoelastic properties of the gum results in good chewing texture. However, these same properties cause the gum to behave like a cold flow substance. As a result, the gum diffuses inside the pores of a substrate after deposition, but behaves like a “tough solid” during attempted removal, leaving behind gum residue. At ambient temperature and body temperature, for conventional gum cuds, there is no significant change in viscoelasticity.

The subject matter disclosed herein provides for gum bases that have less removing residue than the conventional chewing gum. Use of thermosensitive polymers to formulate the insoluble of gum base can alter the viscoelasticity and therefore, gum cud removability.

### 2.1.1 Thermosensitive Polymers

The presently disclosed subject matter addresses the need of removable gum from surfaces and substrates through incorporation of thermosensitive polymers in the gum base composition.

Thermosensitive polymers undergo a phase transition at a Lower Critical Solution Temperature (LCST) in aqueous solution versus ordinary polymers. Below the LCST, the polymer favorably interacts with water to form a hydrated conformation. Cross-linked thermosensitive polymers, in one non-limiting example, can swell and form a hydrogel. This change in viscoelasticity causes the composition to become more fluid-like or solid-like. In contrast, at temperatures above the LCST, the thermosensitive polymer dehydrates or shrinks, and behaves like an ordinary polymer. The removability of the gum base is thereby increased.

In certain embodiments, a thermosensitive polymer can have a LCST or Volume Phase Transition Temperature (VPTT) in the range of from about 0° C. to about 40° C. In certain embodiments, the temperature range is from about 20° C. to about 37° C. In certain embodiments, the thermosensitive polymer has a LCST of from about 25° C. to about 35° C.

In certain embodiments, the thermosensitive polymers include poly(N-isopropylacrylamides) (PNIPAA). In specific embodiments, the thermosensitive polymer is linear poly(N-isopropylacrylamide). In certain embodiments, the thermosensitive polymer includes branched or cross-linked poly(N-isopropylacrylamides). In certain embodiments, the degree of cross-linking in the polymer alters the ability of the polymer to dissolve in solution. For example, in certain embodiments, cross-linked gel of PNIPAA undergoes a reversible volume transition. In certain embodiments, the thermosensitive polymer is a cross-linked poly(N-isopropylacrylamide) with a transition temperature of about 20° C. In certain embodiments, the thermosensitive polymer is a cross-linked poly(N-isopropylacrylamide) with a transition temperature of about 30° C.

In certain embodiments, the presently disclosed subject matter can include block copolymers. In certain embodiments, the block polymer is polyoxypropylene-polyoxyethylene. In certain embodiments, the block polymer can include a combination of hydrophilic polyoxyethylene blocks and hydrophobic polyoxypropylene blocks. In certain embodiments, the presently disclosed subject matter can include triblock copolymers. In certain embodiments, the triblock copolymer includes a single propylene oxide (PO) block sandwiched between two ethylene oxide (EO) blocks. In certain embodiments, the LCST of the triblock copolymer can be adjusted by varying the ratio of EO/PO and molecular weight. In certain non-limiting embodiments, the one or more thermosensitive polymers of the presently disclosed subject matter comprise triblock copolymer polyoxyethylene-polyoxypropylene-polyoxyethylene and ethylene oxide with a molecular weight in the range of from about 1000 g/mole to about 4000 g/mole. In certain non-limiting embodiments, the triblock copolymer polyoxyethylene-polyoxypropylene-polyoxyethylene includes from about 1% to about 40% by weight ethylene oxide.

In certain embodiments, the triblock copolymer can have LCST or VPTT in the range of about 0° C. to about 40° C. In certain embodiments, the temperature range is about 20° C. to about 37° C. In certain embodiments, the block polymer is polyoxypropylene-polyoxyethylene and the transition temperature is about 37° C. In certain embodiments, the block polymer is polyoxypropylene-polyoxyethylene, and the transition temperature is about 15° C. In certain embodiments, the block polymer is polyoxypropylene-polyoxyethylene and the transition temperature is about 14° C. In certain embodiments, the block polymer is polyoxypropylene-polyoxyethylene and the transition temperature is about 20° C.

In certain embodiments, the content of poly(N-isopropylacrylamide) and/or triblock copolymer polyoxypropylene-polyoxyethylene in the gum base can be in a range of from about 1% to about 35% by weight of the total base composition. In certain embodiments, the content is from about 10% to about 25% by weight of the total base composition. In certain embodiments, the content is about 18.75% by weight of the total base composition. In certain embodiments, the content is about 20.0% by weight of the total base composition. In certain embodiments, the content is about 9.97% by weight of the total base composition.

In certain non-limiting embodiments, the one or more thermosensitive polymers is a N-substituted acrylamide derivative. In certain embodiments, the N-substituted acrylamide derivative is selected from the group consisting of N-n-propylacrylamide, N,N-diethylacrylamide, N-cyclopropylmethacrylamide, and combinations thereof.

In certain non-limiting embodiments, the one or more thermosensitive polymers is a poly(amino acid). In certain embodiments, the poly(amino acid) is selected from the group consisting of methacryloylglycine methylester, methacryloylproline, methacryloylphenylalanine methyl ester, methacryloylalanine methyl ester; polymers containing an Arg-Gly-Asp-Ser sequence or arginine-glycine-aspartic acid-serine blocks (RGDS, SEQ ID NO:1); poly(amino acid)s containing two different pentamer blocks: where one block has a Val-Pro-Gly-Val-Gly (VPGVG, SEQ ID NO:2) sequence, and the second block has a Val-Pro-Gly-X-Gly (VPGXG, SEQ ID NO:3) sequence, in which X can be one amino acid residue selected from the group consisting of Leu, ILE, Met, Val, Glu(COOCH₃), Glu(COOH), Cys, His, LysNH₃, Lys and Asp(COOH); and combinations thereof.

In certain non-limiting embodiments, the thermosensitive polymer is a cellulose ether. In certain embodiments, the cellulose ether is selected from the group consisting of hydroxy-propylcellulose, starch ether, poly(ether-ester)block copolymers, chitosan-beta-glycerophosphate and combinations thereof.

In certain embodiments, the at least one thermosensitive polymer is a starch ether. In certain embodiments, the starch ether is 3-[2-butoxy(ethoxy)m]-2-hydroxypropyl starch ether (BEmS) (where m=0, 1, or 2).

The gum base of the presently disclosed subject matter can also include one or more colorants, whiteners, and/or antioxidants. In certain embodiments, the colors and whiteners can include, but are not limited to, FD&C-type dyes and lakes, fruit and vegetable extracts, titanium dioxide or mixtures thereof. In certain embodiments, the antioxidants can include, but are not limited to, beta-carotenes, acidulants (e.g., Vitamin C), alpha-tocopherol (Vitamin E), beta, gamma and delta tocopherols, propyl gallate, butylated hydroxyanisole (BHA), butylated hydroxytoluene (BHT) and tertiary butyl hydroquinone (TBHQ). In specific embodiments, the gum base includes optional minor amounts (about one percent or less) of miscellaneous ingredients such as colorants, antioxidants, etc.

### 3. Chewing Gum

The presently disclosed subject matter includes chewing gum formulations comprising the above disclosed gum base compositions. Methods of making the chewing gum formulations are also contemplated.

### 3.1 Formulations

In certain embodiments, the gum base compositions disclosed above can be incorporated into chewing gum formulations. In certain embodiments, the chewing gum formulation can include one of the disclosed water-insoluble gum base compositions and a water-soluble bulking agent portion.

The water soluble portion of the chewing gum typically includes a bulking agent (also called bulk sweeteners) together with minor amounts of secondary components such as flavoring agents (including sensates such as physiological cooling agents, warming agents and tingling agents), high-intensity sweeteners, colorants, humectants, gum emulsifiers, acidulants, fillers, and binders. Typically, the water-soluble portion, sensates, and flavors dissipate during chewing and the gum base is retained in the mouth throughout the chew.

In certain embodiments, bulk sweeteners can include both sugars and sugar alcohols. Bulk sweeteners can constitute from about 5% to about 95% by weight of the chewing gum, more typically, from about 20% to about 80% by weight of the gum, and more commonly, from about 30% to about 60% by weight of the gum. Sugar sweeteners generally include saccharide-containing components commonly known in the chewing gum art, including but not limited to, sucrose, dextrose, maltose, dextrin, dried invert sugar, fructose, galactose, corn syrup solids, and the like, alone or in combination. Sugarless sweeteners include, but are not limited to, sugar alcohols such as sorbitol, mannitol, xylitol, hydrogenated starch hydrolysates, maltitol, erythritol, isomalt and the like, alone or in combination.

In certain embodiments, a variety of flavoring agents can also be used, if desired. Flavoring agents can include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components can also be used. Natural and artificial flavoring agents can be combined in any sensorially acceptable fashion. Included in the general category of flavors are sensates, chemicals which impart physiological sensations in the mouth such as cooling agents, warming agents and tingling agents. Examples of cooling agents include menthol, WS-23, WS-3, WS-5, isopulegol, esters of menthol such as menthyl succinate, menthyl lactate and menthyl glutarate, among others. Warming and tingling agents include capsaicin, piperine, jambu and spilanthol. In certain embodiments, tackifiers include, but are not limited to, natural rosin esters such as glycerol ester of partially hydrogenated rosin, glycerol ester of polymerized rosin, glycerol ester of partially dimerized rosin, glycerol ester of rosin, pentaerythritol esters of partially hydrogenated rosin, methyl and partially hydrogenated methyl esters of rosin, pentaerythritol ester of rosin or mixtures; synthetic resins such as terpene resins derived from alpha-pinene, beta-pinene and/or d-limonene, polyvinyl acetate resin, polyethylene, poly-dl-lactide resin and combinations thereof.

In certain embodiments, the flavor agent can be used in amounts of from about 0.1 to about 15 weight percent of the gum, and preferably, from about 0.2 to about 5 weight percent of the gum. In certain embodiments, the flavoring agent is present in an amount within the range of from about 0.1 to about 10.0 weight percent or from about 0.5 to about 3.0 weight percent of the gum formulation. In certain embodiments, the flavoring agent is present in an amount of about 0.9 weight percent of the gum formulation. In the case of fruit flavored gums, up to about 3% of an acid such as citric acid, malic acid or adipic acid can be added for tartness.

In some embodiments, the chewing gum ingredients can include one or more high intensity sweeteners. As used herein, the term “high intensity sweetener” refers to any substance that is at least twenty times sweeter than sucrose. Such sweeteners include, but are not limited to, saccharin, cyclamate, aspartame, alitame, neotame, other peptide-based sweeteners, sucralose, acesulfame K, stevia (including purified extracts such as rebaudioside A), glycyrrhizin, neohesperidin dihydrochalcone and mixtures thereof. In some embodiments, at least a portion of the high intensity sweetener will be encapsulated. Such encapsulations can be produced by granulation, agglomeration, extrusion and grinding, spray drying, fluid bed encapsulation or any other known means. In certain embodiments, suitable sugar alcohols include sorbitol, mannitol, xylitol, hydrogenated starch hydrolysates, maltitol, and the like, as well as combinations thereof. In certain embodiments, the sugarless gum comprises a combination of a high-potency sweetener with a sugar alcohol, e.g., aspartame and sorbitol. Usage levels will depend on the potency of the sweetener, degree and effectiveness of the encapsulation (if any) as well as the sensory profile desired for the product. Generally, the sweetener can be used in a range of from about 0.005% to about 5% w/w. The sweetener can be used at levels as low as about 0.005% w/w or as low as about 0.05% w/w or as low as about 0.2% w/w. The sweetener can be used at levels as high as about 5% w/w or about 3% w/w or about 2% w/w in the chewing gum composition. In certain embodiments, the high intensity sweetener can be present at a level of from about 0.1% to about 1.0% of the chewing gum ingredients.

In certain embodiments, the gum base additionally includes a combination of synthetic elastomers, natural elastomers, filler, tackifiers, lipids, plasticizers, humectants, and optional minor amounts (about one percent or less) of miscellaneous ingredients such as colorants, antioxidants, etc.

Synthetic elastomers can include polyisoprene, polysiobutylene, isobutylene-isoprene copolymer, polyvinyl acetate, styrene butadiene rubber, vinyl acetate-vinyl laurate copolymer, poly-dl-lactide, glycolic acid-lactide copolymer or mixtures thereof.

Natural elastomers can include natural rubber such as smoked or liquid latex and guayule as well as natural gums such as jelutong, lechi caspi, perillo, massaranduba balata, massaranduba chocolate, nispero, rosindinha, chicle, gutta hang kang or mixtures thereof.

In certain embodiments, fillers include, but are not limited to, magnesium and calcium carbonate, ground limestone and silicate types such as magnesium and aluminum silicate, clay, alumina, talc as well as titanium oxide, mono-, di- and tricalcium phosphate, cellulose polymers such as ethyl, methyl and wood or mixtures thereof, and combinations thereof.

Tackifiers can include natural rosin esters such as glycerol ester of partially hydrogenated rosin, glycerol ester of polymerized rosin, glycerol ester of partially dimerized rosin, glycerol ester of rosin, pentaerythritol esters of partially hydrogenated rosin, methyl and partially hydrogenated methyl esters of rosin, pentaerythritol ester of rosin or mixtures; synthetic resins such as terpene resins derived from alpha-pinene, beta-pinene and/or d-limonene, polyvinyl acetate resin, polyethylene, and poly-dl-lactide resin.

Lipids can include mono, and/or -di, and/or -tri glycerides of alkanoic acids, or of monoenoic acids or of polyunsaturated fatty acids with carbon chain length from C₄-C₂₄ or mixture thereof, hydrogenated and partially hydrogenated mono, and/or -di, and/or -tri glycerides of monoenoic acid and of polyunsaturated fatty acids, acetylated glycerides of fatty acids, lecithin, paraffin wax, microcrystalline and natural waxes such as beeswax and carnauba.

In certain embodiments, plasticizers include, but are not limited to, glycerol triacetate, triethyl citrate, acetyl triethylcitrate, methyl ester of wood rosin and combinations thereof.

In certain embodiments, the gum base includes from about 5 to about 75 weight percent synthetic elastomers, from about 0 to about 30 weight percent natural elastomers, from about 0 to about 15 weight percent filler, from about 5 to about 55 weight percent tackifiers, from about 5 to about 45 weight percent lipids, from about 0 to about 15 weight percent plasticizers and optional minor amounts (about one percent or less) of miscellaneous ingredients such as colorants, antioxidants, etc. In other embodiments, the gum base includes from about 25% to about 60% by weight synthetic elastomers, from about 0% to about 5% by weight natural elastomers, from about 0% to about 40% by weight filler, and from about 15% to about 45% by weight softener, including tackifiers, lipids and plasticizers. In other embodiments, the gum base is substantially free of natural elastomers and filler.

In certain embodiments, humectants are added to the chewing gum in order to optimize the chewability and mouth feel of the gum. In certain embodiments, humectants, also known in the art as plasticizers or plasticizing agents, can constitute from about 0.5% to about 15.0% by weight of the chewing gum formulation. Softeners include, but are not limited to, glycerin, lecithin, and combinations thereof. Further, aqueous sweetener solutions such as those containing sorbitol, hydrogenated starch hydrolysates, corn syrup and combinations thereof can be used as softeners and binding agents in chewing gum formulations. In certain embodiments, the chewing gum formulation contains about 1 percent glycerin by weight. In certain embodiments, the chewing gum formulation contains about 1.4 percent glycerin by weight. In certain embodiments, the gum base compositions as disclosed herein, can be incorporated into a sugarless chewing gum formulation. In certain embodiments, sugarless sweeteners can include components with sweetening characteristics but that are devoid of the commonly known sugars. In certain embodiments, examples include, but are not limited to high-potency sweeteners and/or sugar alcohols.

Combinations of sugar and/or sugarless sweeteners can be used in chewing gum. Additionally, the softener can also provide additional sweetness such as with aqueous sugar or alditol solutions. In certain embodiments, the water-soluble sweetener portion is a mixture of sugar at about 50% by weight of the final chewing gum, dextrose monohydrate at about 10% by weight, and/or corn syrup at about 17% by weight. In certain embodiments, the formulation comprises about 60% by weight sucrose and/or 17% by weight corn syrup. In certain embodiments the formulation comprises about 58.7% by weight sucrose and/or 17% by weight corn syrup.

If a low calorie gum is desired, a low calorie bulking agent can be used. Examples of low calorie bulking agents include: polydextrose; oligofructose (Raftilose); inulin (Raftilin); fructooligosaccharides (NutraFlora); palatinose oligosaccharide; guar gum hydrolysate (BeneFiber); or indigestible dextrin (Fibersol). However, other low calorie bulking agents can be used.

In certain embodiments, the insoluble gum base composition constitutes from about 5% to about 95% by weight of the chewing gum formulation. In certain embodiments, the insoluble gum base composition comprises from about 10% to about 50%, or from about 20% to about 35% by weight of the chewing gum formulation. In certain embodiments, the thermosensitive polymer constitutes at least about 1%, or at least about 2%, or at least about 3%, or at least about 4%, or at least about 5% by weight of the chewing gum formulation. In certain embodiments, the thermosensitive polymer constitutes no more than about 10% or no more than about 8% or no more than about 6% by weight of the chewing gum formulation. In certain embodiments, the content is in the range of from about 2% to about 6% by weight of the chewing gum formulation.

### 3.2 Methods of Making

In certain embodiments, chewing gum is manufactured by sequentially adding the various chewing gum ingredients to a commercially available mixer known in the art. In certain embodiments, after the ingredients have been thoroughly mixed, the gum mass can be discharged from the mixer and shaped into the desired form such as by rolling into sheets and cutting into sticks, extruding into chunks or casting into pellets.

In certain embodiments, the ingredients are mixed by first melting the gum base and adding it to the running mixer. In certain embodiments, the base can be melted in the mixer itself. In certain embodiments, color or emulsifiers can be added at this time. In certain embodiments, a softener, for example, glycerin, can be added at this time along with syrup and a portion of bulking agent. In certain embodiments, further portions of the bulking agent can then be added to the mixer. In certain embodiments a flavoring agent is added with the final portion of the bulking agent. In certain embodiments, a twice coated sweetener can be added after the final portion of bulking agent and flavor have been added.

In some embodiments a coating can be applied to the extruded chewing gum. In certain embodiments, this is accomplished by pan coating the expanded chewing gum piece. In a pan coating process, centers (e.g., expanded chewing gum pieces) are tumbled in a pan while a coating syrup, typically a sugar or sugar alcohol solution, is applied, for instance by spraying or ladling. Between applications of the coating syrup, the pellets are dried, preferably by passing a current of heated and/or dried air over or through the pellet bed. Numerous layers of coating are built up, often alternating with applications of powdered coating material or an inert filler to accelerate the build-up of the coating. A final layer of a polishing compound, for example carnauba wax, can be applied. In addition to sugar (sucrose), preferred coating materials include maltitol, isomalt, xylitol, sorbitol and erythritol, although others can be used as well. In addition to the coating material, the coating syrup can include film forming agents such as Gum Arabic, high intensity sweeteners, flavors and colors.

### EXAMPLES

The presently disclosed subject matter will be better understood by reference to the following Examples, which are provided as exemplary of the disclosed subject matter, and not by way of limitation.

### Example 1

### Preparation of Gum Base with Thermosensitive Polymers

This example provides the preparation of gum bases with thermosensitive polymers.

A. Preparation

The gum base was formulation using cross-linked poly(N-isopropylacrylamide) with a transition temperature threshold of 20° C. The gum base was made according to formulation #1 in Table 1.

TABLE 1
Chewing gum bases containing thermosensitive polymers

| | | | | | | | Control |
|---|---|---|---|---|---|---|---|
| | #1 | #2 | #3 | #4 | #5 | #6 | base |
| | % | % | % | % | % | % | % |
| Isoprene- | 9.52 | 9.52 | 10.15 | 10.15 | 11.42 | 10.15 | 10.0 |
| isobutylene | | | | | | | |
| Polyvinyl | 22.69 | 22.69 | 24.2 | 24.2 | 27.22 | 24.2 | 23.9 |
| acetate | | | | | | | |
| Terpene resin | 15.62 | 15.62 | 16.66 | 16.66 | 18.73 | 16.66 | 16.5 |
| PNIPAA-20° C. | 18.75 | — | — | — | — | — | — |
| PNIPAA-30° C. | — | 18.75 | — | — | — | — | — |
| Pluronic L31 | — | — | 20.0 | — | — | — | — |
| Pluronic L101 | — | — | — | 20.0 | — | — | — |
| Pluronic L121 | — | — | — | — | 9.97 | — | — |
| Pluronic L81 | — | — | — | — | — | 20.0 | — |
| Hydroxylated | 6.25 | 6.25 | — | — | — | — | — |
| lecithin | | | | | | | |
| Glycerol | 5.36 | 5.36 | 5.72 | 5.72 | 6.44 | 5.72 | 5.6 |
| monostearate | | | | | | | |
| Coco powder | 0.44 | 0.44 | 0.46 | 0.46 | 0.52 | 0.46 | 0.58 |
| Hard fat | 11.92 | 11.92 | 12.72 | 12.72 | 14.31 | 12.72 | 12.5 |
| Shortening | 4.40 | 4.40 | 4.70 | 4.70 | 5.28 | 4.70 | 4.7 |
| Lecithin | 4.53 | 4.53 | 4.83 | 4.83 | 5.44 | 4.83 | 4.8 |
| Calcium | 0.50 | 0.53 | 0.54 | 0.54 | 0.63 | 0.54 | 21.4 |
| carbonate | | | | | | | |
| BHT | 0.02 | 0.02 | 0.02 | 0.02 | 0.03 | 0.02 | 0.03 |

In a gum base mixer (Plastograph from Brabender Corp., Rochelle Park, N.J.) set at 120° C., the butyl rubber was heated and stirred with a sigma blade stirrer until the material reached a fine particulate consistency. At this point approximately ½ of the terpene resin and all of the coco powder were added and stirred for 10 minutes. A second portion of the resin was added and stirred. This procedure is repeated until all the resin was added. When the elastomeric material had achieved a substantially single homogeneous plastic mass, approximately ½ of the low molecular weight polyvinyl acetate was added and stirred for about five minutes. The remaining portion was added and stirred for another five minutes. Then, the hard fat was added and stirred for about 10 minutes followed by step-wise additions of the monoglyceride and shortening in ⅓ portions. This was followed by stirring for about five minutes for each portion. Then, antioxidant BHT was added with five minutes of stirring, followed by the addition of lecithin. The mixture was stirred for 5 minutes under a reduced temperature (to about 65° C.). Lastly, cross-linked poly(N-i sopropylacrylamide) (Carbomer, Inc., San Diego, Calif.) and Hydroxylated lecithin (American Lecithin Company, Oxford, Conn.) were added with stirring for another 15 minutes.

This process was repeated for to produce formulations #2-#6. Formulation #2 used cross-linked poly(N-isopropylacrylamide) with transition temperature at 30° C. (PNIPAA-30° C.) (Carbomer, Inc., San Diego, Calif.). Formulation #3 used triblock copolymer of polyoxyethylene-polyoxypropylene with LCST at 37° C. (PLURONIC L31, BASF Corporation, Mount Olive, N.J.). Formulation #4 used triblock copolymer of polyoxyethylene-polyoxypropylene with LCST at 15° C. (PLURONIC L101, BASF Corporation, Mount Olive, N.J.). Formulation #5 contained triblock copolymer of polyoxyethylene-polyoxypropylene with LCST at 14° C. (PLURONIC L121, BASF Corporation, Mount Olive, N.J.). Formulation #6 contained triblock copolymer of polyoxyethylene-polyoxypropylene with LCST at 20° C. (PLURONIC L81, BASF Corporation, Mount Olive, N.J.).

B. Results

The resulting base had comparable consistency with conventional gum base.

### Example 2

### Preparation of Gum Formulations

Chewing gum was made by mixing one of the gum bases prepared in Example, with additional components according to formulations #7 and #8 in Table 2. The gum was prepared by following a standard procedure known in the art.

TABLE 2
Chewing gum formulations

| | #7 | #8 | #9 | control gum |
|---|---|---|---|---|
| | % | % | % | % |
| Formulation #1 | 22.4 | — | — | — |
| Formulation #2 | — | 22.4 | — | — |
| Control Base | — | — | 19.9 | 21 |
| PLURONIC L121 | — | — | 2.2 | — |
| Sucrose | 59.7 | 59.7 | 60 | 59.7 |
| Corn syrup | 17 | 17 | 17 | 17 |
| Glycerin | — | — | — | 1.4 |
| Flavor | 0.9 | 0.9 | 0.9 | 0.9 |

### Example 3

### Preparation of Gum from Triblock Copolymer of Polyoxyethylene-Polyoxypropylene with LCST at 14° C.

Chewing gum was prepared by mixing a control gum base with additional components according to the formulation #9 in Table 2.

In a gum base mixer (Plastograph from Brabender Corp., Rochelle Park, N.J.) set at 65° C., the control gum base was heated and stirred with a sigma blade stirrer until the material reached a fine particulate consistency. Then, approximately ½ of the triblock copolymer of polyoxyethylene-polyoxypropylene was added and stirred for 10 minutes. A second portion of the thermosensitive polymer was added and stirred. When the material had achieved a substantially single homogeneous plastic mass, sucrose and corn syrup were added, followed by about 15 minutes of stirring. Lastly, the flavor was added and the mixture was stirred for an additional 5 minutes.

The resulting gum had a similar texture to conventional gum.

### Example 4

### Gum Removability Tests

This Example analyzes the removability of the chewing gum formulations #7, #8, and #9.

A. Preparation

Chewing gum formulations #7, #8, and #9, according to Examples 2 and 3, and a control were washed with water. Each sample was taken out of the water and placed on a concrete surface, with a release paper covering the top of the gum. Gum samples were then sandwiched between two concrete blocks and pressed with weight of more than 120 lbs. The gum samples between the concrete blocks were heated to 90° F. for 24 hours. After removing the concrete blocks and the release paper, the gum samples were aged for 3 days at ambient temperature. A mechanical sweeper (Tennant 5700 XP) was then used to remove the gum samples from the concrete block.

B. Analysis

The percentage of each gum sample removed from the concrete block is recorded in Table 3.

TABLE 3
Gum removability test results

| | Area removed |
|---|---|
| Gum | % |
| formulation #7 | 53.3 |
| formulation #8 | 98.7 |
| formulation #9 | 70.0 |
| control | 0 |

C. Results

The results in Table 3 indicate that the control sample was not removable. In contrast, the majority of chewing gum formulations #7-#9 were removable.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications publications product descriptions, and protocols are cited throughout this application the disclosures of which are incorporated herein by reference in their entireties for all purposes.

1. A chewing gum base comprising at least one thermosensitive polymer.

2. The chewing gum base according to claim 1, wherein the thermosensitive polymer has a Lower Critical Solution Temperature (LCST) of from about 0° C. to about 40° C.

3. The chewing gum base according to claim 2, wherein the thermosensitive polymer has a LCST of from about 20° C. to about 37° C.

4. (canceled)

5. The chewing gum base according to claim 1, wherein the at least one thermosensitive polymer is selected from the group consisting of: poly(N-isopropylacrylamide), cross-linked poly(N-isopropylacrylamide), polyoxypropylene-polyoxyethylene block copolymers, triblock copolymer polyoxyethylene-polyoxypropylene-polyoxy ethylene, N-substituted acrylamide derivatives, hydrophobic poly(amino acid), cellulose ethers, poly(ether-ester)block copolymers, chitosan-beta-glycerophosphate, and combinations thereof.

6. The chewing gum base according to claim 5, wherein the at least one thermosensitive polymer is N-substituted acrylamide derivative, wherein the N-substituted acrylamide derivative is selected from the group consisting of N-n-propylacrylamide, N,N-diethylacrylamide, N-cyclopropyl methacrylamide, and combinations thereof.

7. The chewing gum base according to claim 5, wherein the at least one thermosensitive polymer is a hydrophobic poly(amino acid), wherein the hydrophobic poly(amino acid) is selected from the group consisting of methacryloyl glycine methyl ester, methacryloyl proline, methacryloyl phenylalanine methyl ester, methacryloyl alanine methyl ester, and combinations thereof.

8. The chewing gum base according to claim 5, wherein the at least one thermosensitive polymer is cellulose ether.

9. The chewing gum base according to claim 8, wherein the cellulose ether is hydroxy-propylcellulose.

10. The chewing gum base according to claim 1, wherein the at least one thermosensitive polymer is triblock copolymer polyoxyethylene-polyoxypropylene-polyoxyethylene, and wherein the base further comprises from about 1 to about 40% by ethylene oxide.

11. The chewing gum base according to claim 1, wherein the one or more thermosensitive polymers is present in an amount of from about 1% to about 35% by weight.

12. The chewing gum base according to claim 1, wherein the one or more thermosensitive polymers is present in an amount of from about 10% to about 25% by weight.

13. (canceled)

14. A chewing gum formulation comprising the chewing gum bases according claim 1.
